(19) United States
(12) Patent Application Publication
(10) Pub. No.: US 2022/0261848 A1
(43) Pub. Date: Aug. 18, 2022

(54) MICRO INFLUENCER HYPERLINKING

(71) Applicant: Kwikclick, LLC, Murray, UT (US)

(72) Inventor: Fred Cooper, Farmington, UT (US)

(21) Appl. No.: 17/589,844

(22) Filed: Jan. 31, 2022

Related U.S. Application Data
(60) Provisional application No. 63/143,362, filed on Jan. 29, 2021.

(51) Int. Cl. G06Q 30/02

(52) U.S. Cl. CPC G06Q 30/0255; G06Q 30/0269

(57) ABSTRACT

Disclosed herein is a method that allows sellers of products to enroll an individual product in a multi-level marketing (MLM) system. A first user may provide criteria that is used to identify sets of advertisement data that match the filter criteria and filtered advertisement data may be sent to a user device such that the user can generate or update marketing materials for selling the product when attempting to increase sales of the product. By providing sets of filter data and evaluating advertisements that have proven successful, a user may generate advertisements that are more effective. Advertisements and codes that are associated with this first user may be sent to other users who may purchase the product at a discount by using the code after which commissions may be provide to the first user based on use of the code. Users that purchase the product may the sell that product.

### CROSS-REFERENCE TO RELATED APPLICATION

The present application claims the priority benefit of U.S. provisional application No. 63/143,362 filed Jan. 29, 2021, the disclosure of which is incorporated herein by reference.

### BACKGROUND OF THE INVENTION

### Field of the Disclosure

The present disclosure is generally related to influence-based hyperlinking. More specifically, the present disclosure is related to micro-influencer hyperlinking in multi-level marketing systems.

### Description of the Related Art

A Multilevel marketing (MLM) system is a sales strategy used by some direct sales companies, which is used to encourage existing distributors to recruit new distributors who are paid a percentage of their recruits' sales. The recruits are the distributor's “downline.” Distributors also make money through direct sales of products to customers. Amway, which sells health, beauty, and home care products, is an example of a well-known direct sales company that uses multilevel marketing.

Multilevel marketing is a legitimate business sales strategy. One problem is that the MLM is organized as a pyramid tree. However, pyramid “schemes” that use money from new recruits to pay people at the top rather than those who perform the work is illegal. These pyramid schemes involve taking advantage of people by pretending to be engaged in legitimate multilevel or network marketing. You can spot pyramid schemes by their greater focus on recruitment than on product sales.

One issue in determining the legitimacy of a multilevel marketing company is whether it sells its products primarily to consumers or to its members who must recruit new members to buy their products. If it is the former, the company is likely a legitimate multilevel marketer. If it is the latter, it could be an illegal pyramid scheme.

Although each MLM company dictates its own specific financial compensation plan for the payout of any earnings to their respective participants, the common feature that is found across all MLMs is that the compensation plans theoretically pay out to participants only from two potential revenue streams. The first is paid out from commissions of sales made by the participants directly to their own retail customers. The second is paid out from commissions based upon the wholesale purchases made by other distributors below the participant who have recruited those other participants into the MLM; in the organizational hierarchy of MLMs, these participants are referred to as one's down line distributors.

MLM salespeople (distributors) are, therefore, expected to sell products directly to end-user retail consumers by means of relationship referrals and word of mouth marketing, but most importantly they are incentivized to recruit others to join the company's distribution chain as fellow salespeople so that these can become down line distributors.

Currently, in order to join an MLM, there is an initiation fee, which is a barrier against those that just wish to refer a single product they like. Current multi-level marketing (MLM) systems do not take full advantage of the internet and how consumers can influence other consumers to make purchases. Also, current MLM systems do not incorporate incentivizing users of a multi-level marketing system by offering a dynamic commission tree. In addition, there is no current MLM system that utilizes the money or funds dedicated to discounts or coupons to be reincorporated into a multi-level marketing system to incentive consumers to make purchases and advertise the product that they purchased. Further, current MLMs do not rank users based on sales of an individual product, service, or campaign and certainly don't facilitate the optimization of ad creation by allowing users to view the most successful ads for a specific item, location, market, demographic, etc. What are needed are new methods that allow users to more easily promote the sale of products.

### SUMMARY OF THE PRESENTLY CLAIMED INVENTION

The presently claimed invention is directed to a method and to a non-transitory computer-readable storage medium where a processor executes instructions out of a memory to implement a method for tracking and promoting product sales. In a first embodiment, the presently claimed method includes receiving data from a first user device that identifies a set of filter criteria, identifying promotional data by comparing the set of filter criteria to data associated with a product, sending the advertisement data associated with the product to the first user device, receiving new advertising data related to the product that can be shared with a second user device, and providing the new advertising data to the second user device.

In a second embodiment a processor may execute instructions out of a memory to implement functions of the presently claimed method. Here again the method may include receiving data from a first user device that identifies a set of filter criteria, identifying promotional data by comparing the set of filter criteria to data associated with a product, sending the advertisement data associated with the product to the first user device, receiving new advertising data related to the product that can be shared with a second user device, and providing the new advertising data to the second user device.

### BRIEF DESCRIPTION OF THE DRAWINGS

FIG. 1 illustrates a system 100 for Multi-Level Marketing of products via a set of computing devices.

FIG. 2 illustrates a method that may be performed by a computer such as the administration computer of FIG. 1.

FIG. 3 illustrates a series of steps that may be performed at a user device when advertisements are evaluated and ranked based on a set of criteria for identifying successful advertisements and for developing new advertisements.

FIG. 4 illustrates steps that may be performed at an administration computer that communicates with a user device.

FIG. 5 illustrates a computing system that may be used to implement an embodiment of the present invention.

### DETAILED DESCRIPTION

Disclosed herein is a method that allows sellers of products to enroll an individual product in a multi-level marketing (MLM) system. A first user may provide criteria that is used to identify sets of advertisement data that match the filter criteria and filtered advertisement data may be sent to a user device such that the user can generate or update marketing materials for selling the product when attempting to increase sales of the product. By providing sets of filter data and evaluating advertisements that have proven successful, a user may generate advertisements that are more effective. Advertisements and codes that are associated with this first user may be sent to other users who may purchase the product at a discount by using the code after which commissions may be provide to the first user based on use of the code. Users that purchase the product may the sell that product. Here the first user may be considered upline of a second user that purchased the product based on marketing materials generated by the first user and provided to the second user. This second user may also be allowed to update marketing materials or to generate their own advertisements relating to selling the product.

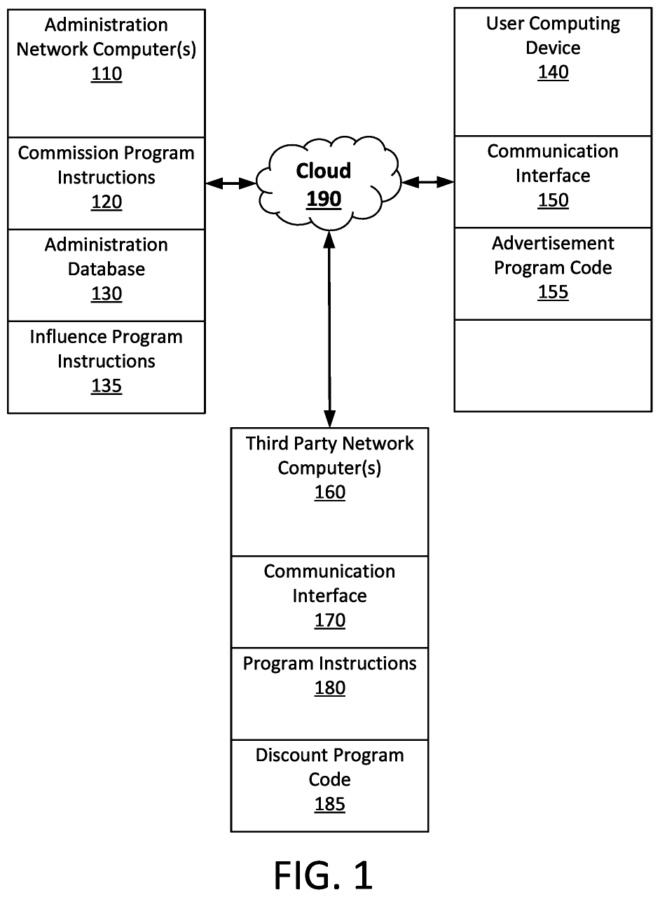

An administration network computer, as shown in FIG. 1, identifies that a product has been purchased from a user(s) of the system [first user]. The system may generate an embedded coded hyperlink that connects (links) the referrer to the purchaser(s). This link may be shared automatically or manually depending on the referrer's preference. The computer may then automatically pay remuneration, in the form of a commissions, referral, and/or finder fees, to the first user. Additionally, the purchaser(s) becomes a second user(s) of the system. Should a new individual buy the same product from the second user(s), another embedded coded link may connect the first user to not only the second user but the new individual(s) as well. Both the first and second user of the system are remunerated for the new individual(s) purchase. This wave of creating and recreating users (1, 2, 3, etc.) based on purchases and linking them together may be indefinitely iterative. Remuneration on this specific product may be paid to all users linked together in the system, each time a purchase is made. The links may be unique and are fixed to each good or service being referred.

FIG. 1 illustrates a system 100 for Multi-Level Marketing of products via a set of computing devices. The system of FIG. 1 includes an administration computer or “administration network” computer 110, a user computing device 140 (user device), and a third party network computer 160. Each of the devices of FIG. 1, the administration network computer 110, the third party network computer 160, and user device 140 may communicate with each other via the communications network 190 such as the Internet or a cloud.

A memory at the administration network computer 110 may store commission program instructions 120 and influence program instructions 135 executed by a computer processor, and an administration database 130. User device 140 of FIG. 1 may be any user device such as a laptop, smartphone, tablet, computer, or smart speaker which may include a user device communication interface 150 which may be a network interface and a set of influence program code instructions 155 executed by a computer processor. The third party network computer 160 of FIG. 1 may include program instructions 180 and discount program code instructions 185 executed by a computer processor, a memory, and a communication interface 170 which may be a network interface. In certain instances, a processor at the administration network computer 110 may receive data regarding sales, execute notification program instructions, track rankings, and send notifications to users. In such an instance, the administration network computer 110 may receive the sales data from the third party network computer 160 such that rankings can be identified and notifications can be sent to user devices from administration network computer 110.

Use of the system may be as follows. A user submits a request to register a product with the administration network computer 110 via a set of discount program code instructions 185 on a third party network computer 160. A set of influence program instructions 135 on the administration network computer 110 determine if the requested registration is valid under a set of rules. If the request for registration is valid, the product is registered and stored in the administration database 130. A user connects a user device 140 to the communication network 190 via the user device communication interface 150. Through the communication network 190 the user device 140 connects with the third party network computer 160 via the third party network communication interface 170. A set of third party network program instructions 180 and discount program code instructions 185 allow the user to purchase the registered product from the third party network computer 160 and apply a discount to the product if a user has a code. Confirmation of the purchase and the code are then sent from the third party network computer 160 to the administration network computer 110. If the user did enter a code, a set of administration network commission program instructions 120 will pay commission to at least another user that is associated with the code. A new code is then generated by the administration network 110 per the administration network commission program instructions 120. The new code is associated with the user of the user device 140. The commission and the newly generated code are stored in the administration network administration database 130. The administration network computer 110 may also receive sets of filter data from a user device 140 and the administration network computer 110 may then send advertisements, marketing data, or other promotional materials to the user device 140 that match a set of criteria included in the filter data. A user of user device 140 may then be allowed to update marking materials or generate their own advertisements that may be provided to and shared by the administration network computer 110 with other users.

Program code instructions of the administration network computer 110 may be organized as one or more software modules that include instructions for performing different functions. For example, a set of commission program instructions 120 may include base program instructions, advertising program instructions, calculation program instructions, and vendor program instructions. the administration network computer 110 may also access one or more databases, such as a compensation database that stores compensation data and a code database that stores program code or web link data, for example. The administration network computer 110 may accept sellers (third parties), where a “single product tree” multi-level marketing method is formed, comprising the steps of, providing at least one product, providing an MLM system with a seller's commission structure, and providing at least one seller of a product with its associated commission structure. The term “single product tree” refers to a unique structure for associating distributors of an MLM organization where products are used to identify relationships between distributors and commissions paid to related distributors. This “single product tree” structure allows for a particular user to be considered a sponsor or any other user based on that user sending promotions to other users to purchase a product that those other users were not previously associated with.

The administration network computer 110 may also provide a plurality of buyers/distributors, allow the at least one first seller to enroll a product to the MLM system, and allow at least a first buyer/distributor to purchase the product. Other functions that may be performed by the administration network computer 110 include allowing the at least the first buyer/distributor to advertise the product to other potential buyers/distributors and allowing at least a second buyer/distributor to buy the advertised product. Here the seller may set a commission structure for a product, may enroll the product into the MLM system, may allow the first, second and so on purchasers/distributors to purchase and advertise the product.

Once products have been enrolled with a commission structure, the administration network computer 110 may allow the purchasers/distributors to receive a commission based upon the seller's product commission structure. A distributor may refer to the non-salaried workforce selling the company's products or services. Here the earnings of the participants may be derived from a pyramid-shaped or binary compensation commission system. The term product may refer to articles or substances manufactured or refined for sale. Product may refer to an individual product, a line of products such as unique brand and model of drill, or a group of products such as all power tools. A service may refer to a system supplying a public need such as transport, communications, or utilities such as electricity or water.

A service which may be an act of dealing with a customer in a store, restaurant, or hotel by taking their orders, showing, or selling them goods. Additionally, a service which may be work that someone does or time that someone spends working for an organization, or a business that offers a particular type of help or work., The system 100 of FIG. 1 may distribute commissions according to an MLM tree or commission tree that is a payment structure in which commissions are given out at different percentages at different levels of the MLM tree, for example. In such a system distributor (users) that perform the sale or that are at a level that is “closer” to the distributor that performed the sale may receive larger commissions than distributors that are “farther” from the sale.

In another example, a first MLM distributor that performs a sale may receive a higher percentage than a second distributor that sponsored the first distributor, and a third distributor that signed up the second distributor may receive a lower commission than the commission received by the second distributor for the sale. Distributors in an MLM tree may be referred as “downline” or “upline” distributors depending on where different users rank on the MLM tree. For example, a first user that sponsors a second user is “upline” from the second user and the second user is “downline” from the first user in the MLM tree. Furthermore, any user/distributor that the second user sponsored would be considered downline from the second user and could be downline from the first user as well for a given MLM product tree. When a “single product tree” structure is used to identify commissions, users that are downline from the second user may not be downline from the first user based on the second user purchasing and advertising products not associated with the first user. When the first user purchases the product initially advertised by the second user, the second user may be considered upline of the first user after the first user for this product. Because of this, the second user is not relegated to always be downline from the first user just because the first user originally sponsored the second user to become an MLM distributor.

An MLM system which may be referred to as network marketing, may be a business model that depends on person-to-person sales by independent representatives, who may work from their home. A network marketing business may require the independent representatives to build a network of business partners or salespeople to assist with lead generation and closing sales. End of life of MLM tree may refer to the end of the MLM tree in which the commission tree may be restructured or eliminated. For example, further participants in the MLM may not receive a commission, the commission tree may “start up” (be reinitiated from a starting point) again, or the commission tree may be restructured in some other way. An existing MLM system may refer to currently existing or established companies that use the sales strategies to encourage existing distributors to recruit new distributors who are paid a percentage of their recruits' sales.

The administration network computer 110 may perform data security functions as well as functions associated with operation of an MLM algorithm that may calculate user compensation. Administration network computer 110 may be able to connect to a software application store, like the “Apple App Store,” where a program application can be downloaded from. Data security may refer to the process of protecting data from unauthorized access and data corruption throughout its lifecycle. Data security may include data encryption, tokenization, and key management practices that protect data across all applications and platforms. An MLM algorithm may refer to a calculation performed using a compensation decay rate to calculate the commissions for downline participants.

The commission program instructions 120 of FIG. 1 may cause a computer processor in the administration network computer 110 to continuously poll for user data (e.g., data of a user who may be a product purchaser or product distributor) from another processor executing a set of program instructions 180 at a third party network computer 160. Once the processor of the administration network computer 110 receives the user data, commissions may be calculated using the commission program instructions 120 of FIG. 1. These commissions may be calculated based on data stored in an administration network compensation database. Downline and upline commissions for the other users (product purchasers/distributors) within the MLM tree may be paid. The administration network compensation database may be included within the administration database 130 of FIG. 1 or it may be a separate database accessible by the administration network computer 110. Alternatively, instead of the administration network computer 110 polling a third party network computer 160, the third party network computer 10 may send the user data to the administration network computer 110 after a sale has been made.

An upline may refer to the MLM distributors that recruits work for as salespeople to sell the products or services. A downline may refer to the recruits the MLM distributors are able to secure as participants in the MLM system. Downline MLM trees may go across country boundaries and commissions may be paid out for an MLM tree even though the participants in the MLM tree may not reside in the same country. The commissions may be calculated for the appropriate exchange rate to ensure participants are paid in their residing countries currency in the correct amount.

A processor executing the commission program instructions 120 of FIG. 1 may continuously poll for user data from the third party network computer 160. The administration network computer 110 may then receive the user data from the third party network computer 160. Then the administration network computer 110 may determine whether the user entered a code. If the user did enter a code, the processor at the administration network computer 110 may extract the code and then access the administration network compensation database to identify one or more different spheres of influence or potential product purchasers/distributors levels. Such a code may have been received from user device 140 based on user inputs.

The processor at the administration network computer 110 may also associate a code for each of the different spheres of influence. The administration network computer 110 may then extract a corresponding commission for the code that was retrieved from in the administration network compensation database. The administration network computer 110 may then send the commission to the user (purchaser/distributor). The administration network computer 110 may track profits and payments as well as track taxes for users enrolled in the MLM system. The tracking of profits and payments may refer to the MLM system tracking the profits of the MLM and tracking the payments or commissions paid out to participants. The tracking of taxes may refer to tracking the commissions provided to participants for tax purposes. Then the administration network computer 110 may also compare the extracted code to data stored at an administration network code database a list of users and code sent to followers may be stored. This administration network code database may be the same database as the administration database 130 of FIG. 1 or it may be another database accessible by the administration network computer 110. The administration network computer 110 may extract a user ID and sphere of influence or potential purchaser/distributor by using the extracted code.

The administration network computer 110 may then compare the extracted sphere of influence or potential purchaser/distributor to data stored at the administration network compensation database. The administration network computer 110 may then use the extracted sphere of influence data to extract a corresponding commission from the administration network compensation database. The administration network computer 110 may then send the commission to an upline user. If the user did not enter a code, the administration network computer 110 may then initiate a set of administration network advertising program instructions.

The administration database 130 may store data received from various third parties (various sellers) that are part of a set of MLM trees. This data may contain a product ID, description of the product, an original cost of the product, a discount for the product, a cost of the product with the discount, a compensation plan decay rate, and a link to the product. An advertising link may refer to a link that directs a consumer to a product, service or good.

TABLE 1
Administration Database Data

| | | | |
|---|---|---|---|
| 3rd Party | Home Depot | Home Depot | Furniture Store |
| ID | 654123 | 789654 | 123789 |
| Item | Drill | Table Saw | Couch |
| Original Cost | $59.00 | $119.00 | $999.00 |
| Discount | 15% | 10% | 10% |
| Discount Cost | $50.15 | $107.10 | $899.10 |
| Compensation | 50% | 50% | 30% |
| Decay Rate | | | |

Table 1 table displays data that may be stored at the administration database 130 of FIG. 1. When the administration network computer 110 receives product data from third party network computer 160 it creates a link for the product, stores the received data in the administration network administration database 130, and sends the created link back to the third party network computer 160. The administration network administration database 130 may be used to store data collected from various third parties that enrolled in the multi-level marketing system 100 of FIG. 1. The administration network administration database 130 may store the name of the third party, a user ID, the ID for a product, a description of the product, the original cost of the product, the discount provided by the third party, the cost of the product with the discount, the compensation decay rate or how the downline commissions are calculated, and the link to the product.

The administration database 130 may store data that the administration network computer 110 may access when communicating events with the downlines and uplines, providing dynamic incentives or rewards for a product, distributing marketing materials, providing banking referrals, or distributing materials for suggestive selling, etc. Here, communicating events with downlines and uplines may refer to sending information relating to advertising events to participants of an MLM system. Dynamic incentives and rewards for a product may refer to incentives or rewards that are continuously updated for a product. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media and all audio or video media. Banking referrals may refer to a structured flow of collecting and organizing referrals for banks. Businesses who have been unsuccessful in a credit application process with a bank may be asked for their permission to have their financial information passed to designated finance platforms who can contact the business in a regulated timeframe. Suggestive selling may refer to a sales technique where an employee asks a customer if they would like to include an additional purchase or recommends a product which might suit the client.

The influence program instructions 135 may allow a processor to receive data for a product that could potentially be added to products sold via an MLM organization. This product data may be stored at administration database 130 of FIG. 1. The data may include, for example, a product identifier (ID), a name, a cost, a discount, and/or a compensation decay rate, etc. to associate with the product. The execution of a set of influence program instructions 135 may cause the processor to check whether each parameter value of a set of parameter values included in the received data is allowed under a set of rules. These rules may be stored in a rules database that the processor may access.

As mentioned above user device 140 may include a memory, a processor, and a communication interface 150. The processor of user device 140 may execute instructions out of the memory when a user of user device 140 registers as a member of an MLM organization. Other tasks that a user may perform on user device 140 could include, identifying or connecting with other user devices (e.g., follower user devices), preparing advertisement information to share with follower user devices, receiving advertisement information prepared by other users, accessing product promotions at the third party network computer 160, and purchasing products based on offerings received from the third party network computer 160. Each of the tasks performed by user device 140 may include sending and receiving communications with the administration network computer 110, the third party network computer 160, or other user devices. Promotions prepared at a particular user device may be shared with other user device via administration network computer 110, third party network computer 160, a social media network computer, or directly from one user device to another. User devices may also be required to download and install an application program from an application store, such as the “Apple App store” as part of a process for registering as a member of an MLM organization.

The user device communication interface 150 of FIG. 1 may send and receive data via a communication network 190 which may be a wired and/or a wireless network.

The influence program code instructions 155 may cause the processor to direct the user to a web page associated with a universal resource locator (URL) received in a communication that advertises a product. In certain instances, the URL may be encoded on a QR code. When the QR codes is scanned, a computing device that scanned the QR code may be directed to the web page. A QR code scanner may be an input device, such as a camera. The QR code may contain non-URL data which may be usable by other program instructions. For example, the QR code may contain a pre-generated referral code or a product ID which, when combined with the user's ID, can be used to retrieve a referral code from an administration network code database. This QR code may also include discount information that allows the product to be purchased at a reduced price.

As discussed above the third party network computer 160 of FIG. 1 may include a computer processor a memory, and communication interface 170. This third party network computer 160 may be controlled by various third parties, such as retail stores (stores that sell product consumables, services, service networks, large box stores) or e-commerce sites that allow e-commerce sales. Such e-commerce sites may include an e-commerce shopping cart, that offer products to users at a discount, such as a product discount, in order to use the MLM system of FIG. 1. Product consumables may refer to goods by individuals and businesses that must be replaced regularly because they wear out or are used up. Service networks refer to a collection of people and information brought together on the internet to provide a specific service or achieve a common business objective, such as Angie's List. E-commerce sale may refer to sales of goods and services where the business takes place over the internet, an extra-net, Electronic Data Interchange (EDI), or other online system.

Payment may or may not be made online. Business in this context may be defined as an order placed by the buyer or price and terms of sale negotiated. E-commerce shopping cart may refer to a software used in E-commerce to assist visitors to make purchases online. Upon checkout, the software calculates the total of the order, including shipping and handling, taxes and other parameters the owner of the site has previously set. Retailer may refer to a person or business that sells goods to the public in relatively small quantities for use or consumption rather than for resale. Product discounts may refer to a reduce price or something being sold at a price lower than that product is normally sold for. It is a reduction to a basic price for a good or service. Large box stores may refer to a physically large retail establishment, usually part of a chain of stores, offers a variety of products to its customers. The term sometimes refers, by extension, to the company that operates the store, and which may be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance.

The third party network communication interface 170 of FIG. 1 may send data and receive via a communication network 190 which may be a wired and/or a wireless network.

The third party network program instructions 180 and discount program code instructions of FIG. 1 may be executed by a computer processor after being initiated by a set of third party network base program instructions. These instructions may cause the processor at the third party network computer 160 to prompt user for a discount code and to compare a received code to data stored at a third party network third party database. When a code received from a user matches data stored at the databases, a discount for the selected product may be applied and an order for a product may be processed.

The discount program code instructions 185 may allow a user to register products and a set of associated parameters with the administration network computer 110 so long as the parameters are within the allowed values set by the rules. These product parameters may include, for example, the product ID, the name, the cost, the discount, or the compensation decay rate, etc. mentioned above.

The communications network 190 of FIG. 1 may be the Internet or a cloud. This communication network or any of the communication network interfaces 150 or 170 discussed herein may be a wired and/or a wireless network. Such a communication network, if wireless, which may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

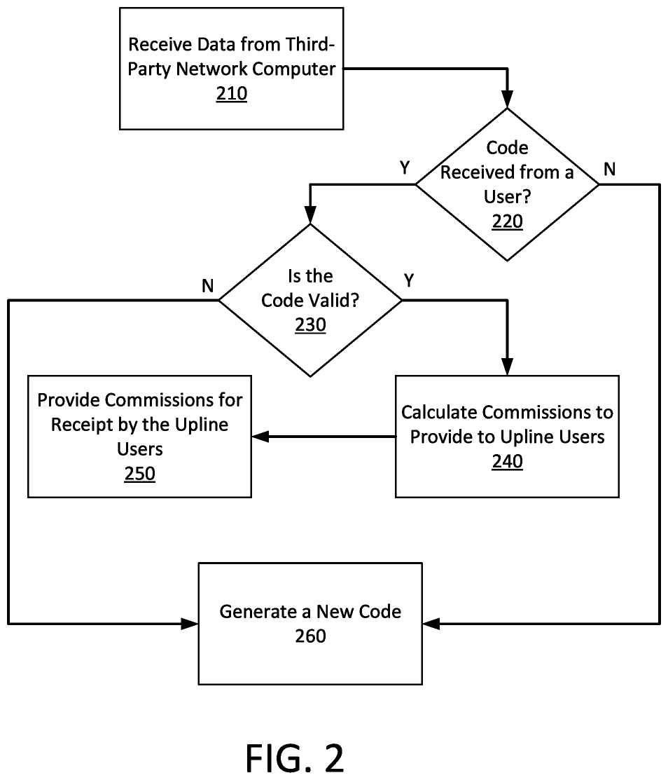

FIG. 2 illustrates a method that may be performed by a computer such as the administration computer of FIG. 1. FIG. 2 begins with step 210 where the administration network computer 110 receives data from the third party network computer 160 of FIG. 1. The received data may contain information on a purchased product and the discount code that can be applied to the purchase. This step may be facilitated by a set of administration network base program instructions stored in memory and executed by a processor. The administration network computer 110 may determine if the data received from the third party network computer 160 contains a code, at step 220. When the data does contain a code, the administration network computer 110 checks that both the product and the code match data stored at the administration network administration database 130 and/or other databases. The product and code may then be checked to see if they are valid at step 230 of FIG. 2. When the code and product are valid, the computer at administration network computer 110 may calculate commissions due to each upline user at step 240.

The commissions may be calculated by using the discount on the product and providing 50% of the discount to the user who supplied the code and then the remaining amount of the discount for the upline users at a 50% decay rate. For example, if the first user purchased a product that was originally $59.00 discounted by 15%, then a second user makes a purchase with the first user's code would receive $3.32 or 50% of the discount. Then any follower of the second user who uses the second user's code would cause the second user to receive 50% of the discount and the first user to receive 50% of the remaining discount or 50% of $3.32, and this may continue until there is only one cent left to pay out as a commission for the upline users. The threshold at which commission stops may be greater or less than one cent and may be set dynamically. This step may be facilitated by administration network calculation program instructions stored in memory and executed by a processor. Then, the administration network computer 110 may distribute the commission to the upline users at step 250 of FIG. 2. Commission may be paid directly to a user via the user device 140 of FIG. 1. The data may be stored in a database, for example, an administration network compensation database discussed above. Whether or not a valid code was entered, the administration network computer 110 may generate a new code for the user such that the user can give the code to followers and receive commission on their purchases at step 260 of FIG. 2. This generated code may be stored in the administration database 130 of FIG. 1 or another database, for example an administration network code database.

A set of administration network base program instructions may instruct the administration network computer 110 to connect to the third party network computer 160, initiate a set of vendor program instructions and initiate a set of calculation program instructions.

A set of administration network calculation program instructions which may be initiated by operation of the administration network base program instructions may instruct the administration network computer 110 to extract the discount received from the third party network computer 160 as well as the compensation plan or commission plan (e.g. its decay rate or commission structure so that each downline gets less and less commission) in order to identify the commissions for the MLM (Multi-Level Marketing) tree. Once identified, this commission data may be stored data in a database at the administration network computer 110 of FIG. 1. A commission may refer to a payment to someone who sells goods that are directly related to the amount sold, or a system that uses such payments. A compensation plan or a commission plan may refer to the decay rate of the commissions provided to the MLM system from the discount offered by the third party, the third party also selects the decay rate to calculate the commissions offered to the first purchaser as well as the percentage offered to the downline participants.

Functioning of the calculation program instructions may be as follows. The process may begin with an administration network computer initiating the calculation. The administration network computer 110 may then extract a discount from the administration network administration database 130, which may be received from the third party network computer 160. Then the administration network computer 110 may extract the compensation plan decay rate from the administration network administration database 130. The administration network computer 110 may then determine the commissions available to the downline users, or the followers of the user that purchased the product.

The commissions may be calculated by using the discount on the product and providing 50% of the discount to the first participant and then the remaining amount of the discount for the downline users at a 50% decay rate. For example, if the first user purchased a product that was originally $59.00 discounted by 15%, the first user to make the purchase would receive $3.32 or 50% of the discount. Then any follower of the user who made the initial purchase would receive 50% of the remaining discount or 50% of $3.32, and this may continue until there is only one cent left to pay out as a commission for the downline users. Then the administration network computer 110 stores the data in the administration network compensation database. The administration network computer 110 sends a request to the user device purchase program instructions for the data stored in the user device user database. Then the administration network computer 110 may receive the user device user database data from the user device 140. The administration network computer 110 may store the received data, as well as the code data, in the administration network code database. The administration network computer 110 may then return to executing the administration network base program instructions.

A set of administration network advertising program instructions, which may be initiated by operation of the administration network commission program instructions 120, may determine the user's sphere of influence or contact list in order to provide the user's potential downline purchasers/distributors with a link and a code for the potential downline purchasers/distributors to become part of the MLM Tree Functioning of the advertising program instructions may be as follows. The process may begin with operation of the administration network commission program instructions 120 causing the administration network computer 110 to initiate the administration network advertising program instructions. The administration network computer 110 then determines if the user entered a code. If it is determined that the user entered a code the code is extracted. The administration network computer 110 compares the extracted code to the administration network compensation database.

The administration network computer 110 then may determine the user's sphere of influence level. If it is determined that the user did not enter a code, then the administration network computer 110 sets the user as the “First Participant”. Then the administration network computer 110 extracts the code for the next sphere of influence level or potential purchaser/distributor to provide the user's followers with a code that would allow them to join the multi-level marketing tree. The administration network computer 110 then may send the code and the link to the product to the user device 140. A set of administration network vendor (those selling products) program instructions, which may be initiated by operation of the administration network base program instructions, may result in data being received from the third party network computer 160. The administration network computer 110 may then store the data in the administration network administration database 130, create a link for the product, send the link back to the third party network 160, and return to executing the administration network base program instructions.

Functioning of a set of vendor program instructions may be as follows. The process may begin with operation of the administration network base program instructions causing the administration network computer 110 to initiate the administration network vendor program instructions. The administration network computer 110 may then receive data from the third party network computer 160. This data may include a product to be enrolled in the MLM system, an original cost of the product, a discount provided by the third party, a cost of the product with the discount, a compensation plan decay rate, etc. Then the administration network computer 110 may create a link for the product for the third party network computer 160. A vendor may be a seller of a product, such as a retailer. The administration network computer 110 may then store the received data and the created link in the administration network administration database 130. The administration network computer 110 may then send the link to the third party network computer 160. The administration network computer 110 may then return to executing the administration network base program instructions.

An administration network compensation database, which may be created through operation of the administration network calculation program instructions, may store various commissions for the different product purchasers/distributors. Table 2 illustrates data that may be stored at a compensation database consistent with the present disclosure. The administration network computer 110 may extract discount information and a compensation plan decay rate to calculate the downline commissions for additional users. This discount, decay rate information, and the sphere of influence levels may be stored in the administration network compensation database discussed above. The administration network compensation database may store information that cross-references a third party, a product ID, product description, the compensation plan decay rate, the various sphere of influence levels, a commission for each sphere of influence level, and a code to be used by the user's followers to enroll in the MLM system 100 of FIG. 1. The administration network compensation database may store a lottery structure for how the commissions are paid to users or freelancers. This lottery structure may refer to a process or thing whose success or outcome is governed by chance. A means of raising money by selling number tickets and giving prizes to the holders of number drawn at random. Freelancers may refer to a person who works as a writer, designer, performer, or the like, selling work or services by the hour, day, job, etc., rather than working on a regular salary basis for one employer.

TABLE 2
Compensation Database Data

| | | | |
|---|---|---|---|
| Third Party | Home Depot | Home Depot | Home Depot |
| ID | 654123 | 654123 | 654123 |
| Item | Drill | Drill | Drill |
| Compensation Decay | 50% | 50% | 50% |
| Rate | | | |
| Sphere of Influence | First | 2 | 3 |
| Level | Participant | | |
| Commission | $3.31 | $1.66 | $0.83 |
| Code | N/A | 654123-SOI2 | 654123-SOI3 |

Table 3 illustrates data that may be store at an administration network code database. This data may identify the codes given to the product purchasers/distributors (users) for the product purchasers/distributors (user) to pass to their potential purchasers/distributors to advertise or promote a product that a user has purchased. The administration network code may also cross-reference a user ID with a product ID, and product name, a sphere of influence (/potential purchaser/distributor), and a code that may be shared with followers.

TABLE 3
Code Database Data

| | | | Sphere of Influence/ | |
|---|---|---|---|---|
| | | | potential purchaser/ | Code for |
| User ID | ID | Item | distributor | Followers |
| JS1234 | 654123 | Drill | First Participant | 654123-SOI2 |
| HY8569 | 654123 | Drill | Second Participant | 654123-SOI3 |
| TB4567 | 789654 | Table | First Participant | 897456-SOI2 |
| | | Saw | | |
| EL51346 | 789654 | Table | Second Participant | 897456-SOI3 |
| | | Saw | | |

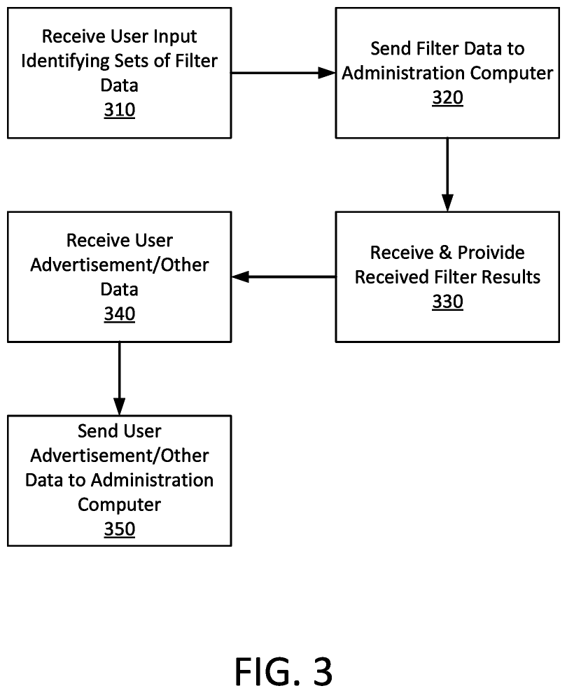

FIG. 3 illustrates a series of steps that may be performed at a user device when advertisements are evaluated and ranked based on a set of criteria for identifying successful advertisements and for developing new advertisements. Here sets of criteria may be provided to an administration computer (i.e. computer 110 of FIG. 1) that the administration computer could use to filter advertisements. A set of filter criteria could be directed to a location, a market, a demographic (e.g. age range, sex, ethnicity, location, and time spent on page), user physical characteristics (e.g. age, sex, eye color, and height), religion, hobbies, technology affiliation, political affiliation, or other details that may be associated with users. A user may enter one or more sets of filter criteria (i.e. filter data) in step 310 of FIG. 3 and that filter criteria may be sent to the administration network computer 110 of FIG. 1 in step 320 of FIG. 2. This administration computer could then compare advertisement data or data associated with specific advertisements to identify advertisements, promotional materials, or marketing materials that match some or all of portions of a set of filter criteria. Such advertisement data may be referred to as promotional data or promotional media. These advertisements may also be ranked and filtered according to respective advertisement rankings. The administration computer may then send any appropriate advertisement data to the user device that matches the set of filter criteria.

Next, in step 330 the advertisement data sent from the administration computer may be received at the user device. A user of the user device then be provided with the advertisement data in step 330. This may include displaying images, audio, or multi-media (audio-video) data to the user of the user device. This advertisement data may also include a ranking assigned to each respective advertisement. A user device may only receive advertisements that are above a certain ranking level or value. Here ranking levels or values may correspond to how successful a particular ad was as measured by a number or sales, a dollar volume of sales, or a number of views, for example.

Once a user reviews the advertisement data, they may generate their own advertisements that target specific types of users. For example, advertisements that match a criterion for which sales of particular types of products were most successful may be used as templates or basis for ideas from which a user may generate a new advertisement. This process may also allow a user to identify criteria for selling products that they distribute. User's may be allowed to generate their own advertisements or may input or select a new set of filter data and provide their new advertisement, filter data, or other data to the administration computer in step 350 of FIG. 3. Advertisement data sent to an administration computer may include media file data of any type and may also include or be associated with a sharing criteria used to distribute their advertisements to other users or contacts. In instances when additional sets of filter data are sent to the administration computer program flow may move back to step 330 of FIG. 3, otherwise a processor at the user device may perform other tasks after step 350.

The process of FIG. 3 may be performed by a user that is tracking the success or ranking of their own advertisements and may update their advertisements or sharing information associated with their advertisements by evaluating data collected and sorted by an administration computer.

Functions may be performed at a user device when a user evaluates or creates advertisement media. This may include a user clicking on a button within a graphical user interface (GUI). A user of the user device may be prompted to enter at least one filter or set of filter criterial. This may include any parameter that is stored in the ranking database so that the user can narrow their advertisement based on what they believe is relevant to their market, for example, item ID, location, time, religion, technology space, political affiliation, etc.

The filter or filters may be used to determine which results are returned by the administrations network computer 110 of FIG. 1. The user may enter multiple filter criteria entries, for example, by separating entries with a comma: Item: 48395, Houston Tex., 2018-2020. As mentioned above, this filter data may be sent to the administration network computer 110. The filters may be used to send an additional piece of data which indicates whether the filter is optional, meaning that if no results match all of the optional filters then at least the results that match the non-optional filters may be used to identify text, media files, error messages notification, or any combination thereof should be provided to a user.

The data provided to the user may then be used by the user to create an add, for example, editing text, editing video, editing pictures, editing sound files, combining files, fragmenting files, etc. As mentioned above advertisement data generated by a user may be sent to an administration computer that may then share it with user devices of the MLM network. In certain instances, advertisement data may be sent directly to other user devices from a user device.

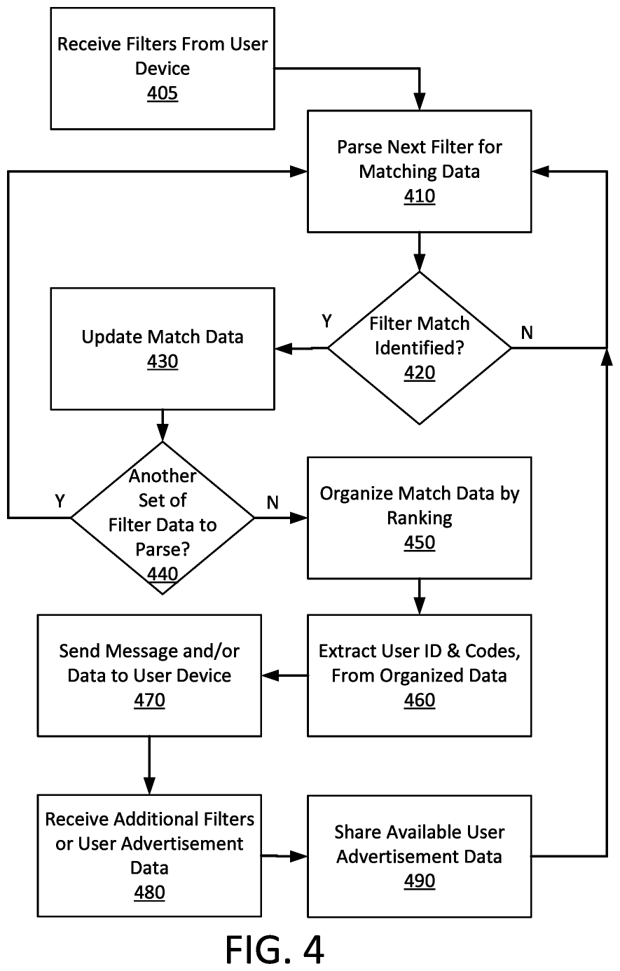

FIG. 4 illustrates steps that may be performed at an administration computer that communicates with a user device. The steps of FIG. 4 may be performed by a processor of the administration network computer 110 of FIG. 1. In step 405, the sets of filter data discussed in respect to FIG. 3 may be received from a user device. Respective sets of this filter data may be parsed in step 410 to identify advertisements that match criteria in a set of filter data to threshold level. For example, when set of filter data includes criteria of sporting equipment market, age range of 20 years to 50 years, and a location of beaches may be used to identify advertisements that have been successful in selling beach related sporting equipment to individuals between the ages of 20 to 50 years old. In certain instances, each criteria entry in a set of criteria may have to be matched to identify corresponding advertisements. In other instances, only some of the criteria may be required. For example, a user may identify that advertisements that match a number of criteria entries (e.g. 1 or 2) or some percentage of the criteria entries (2 out of 3 or 66%). As such, advertisements associated with the sporting equipment market and with the beach may be sent to users of any age when a criteria matching threshold is set at 66%. Rankings of identified advertisements may also be reviewed in step 410. These rankings may be used to eliminate advertisements from a set of advertisements that met the criteria matching threshold. Rankings or ranking levels or values may correspond to how successful a particular ad was as measured by a number or sales, a dollar volume of sales, or a number of views, or other measure.

Next, determination step 420 will identify whether any advertisements met the filter criteria. When no advertisements match the filter criteria, program flow may move back to step 410 where a next set of filter criteria is used to identify matching advertisements. When one or more advertisements meet the filter criteria, program flow may move to step 430 where a set of match data is updated and potentially stored at a database. Determination step 440 may identify whether there is another set of filter data to parse, when yes program flow may move back to step 410 discussed above. When step 440 identifies that there are no other sets of filter data to parse, program flow may move to step 450 where advertisements that meet specific sets of filter criteria may be organized by raking.

Next in step 460 information may be extracted from the advertisement data. This data may include user identifiers (IDs), follower codes, discount codes, rankings, or other information. Next in step 470, message or data may be sent to the user device. Messages sent may identify discrepancies or errors. For example, a message may identify that a set of filter received no matches and may also indicate that the user should provide additional sets of filter data for evaluation. Data sent to the user device may include all or a portion of the advertisement data. This may allow the user to review the advertisement data, view or listen to advertisements, and generate new advertisement data as discussed in respect to step 350 of FIG. 3.

Additional filter data or new user advertisement data may be received in step 480 after which advertisements generated by and included in the new advertisement data may be shared with other user devices. These advertisements may be shared with a user's contacts that are assigned or have characteristics that match a set of sharing filter criteria or demographic that the user wishes to sell a product to. A newly generated advertisement may be shared with contacts or others according to the characteristics that match the sharing filter criteria in step 490. This shared data may identify a product for sale, user IDs to share the product with, identify follower codes, or may identify a discount code that could be applied to a purchase of the product.

A set of instructions referred to as user device purchase program instructions may allow a user device to connect to the third party network computer 160, allow a purchaser/distributor to select a product and an associated link. This process may include, determining whether the purchaser/distributor entered a code, and sending the link and code, if available, to the third party network computer 160.

A set of instructions referred to as purchase program instructions may cause the user device 140 to continuously poll for a request from the administration network computer 110 for user device user database data. The user device 140 may then receive a request from the administration network computer 110 for the user device user database data. Then the user device 140 may send the user device user database data to the administration network computer 110. The user device 140 may then connect to the third party network computer 160. Then the user may select a product from the third party network computer 160. The user may select a link from the third party network computer 160. Then the user device 140 if the user entered a code. If it is determined the user entered a code, the user device 140 may send the code to the third party network computer 160. The user data may be data to purchase the product such as name, address, billing information, etc. The user data sent to the third party network computer 160 may include information from a credit card system. A credit card system may refer to a system that allows cardholders to borrow funds with which to pay for goods and services with the condition that the cardholders pay back the borrowed funds, plus interest, as well as any additional agreed-upon charges.

A user device user database may contain the user's (product purchasers/distributors) followers (sphere of influence) as well as the followers contact information for them to receive commissions on their purchases. A distributor contact list or followers may refer to the recruits or followers on social media that a distributor has secured to participate in their downline. The user device user database may include ratings and recommendations from the users. Rating and recommendation modules may refer to modules in which a company, entity, or person provides ratings and/or recommendations for products, goods, or services.

Table 4 displays data that may be stored at a user device database. The data of table 4 cross-references user information with user follower information. The user device user database stores the user's ID, the followers user ID, codes provided to the followers, the follower's e-mail address, the follower's phone number, and the follower's address. The user device database may store the follower's social media information such as user social media account information (Twitter, Instagram, Facebook, etc.). The user database may contain social media plug-ins for enhanced marketing or social media aggregators. Social media plug ins for enhanced marketing may refer to sharing content with other people through social media platforms, for example a share or like button. The user device user database may contain payment information such as bank accounts, credit card information, PayPal, Venmo, etc. A user ID or ID Enrollment may refer to a participant enrolling in an MLM product tree through an ID, which may be unique to each participant in the MLM system. Social media aggregators may refer to a tool that allows a person to collate posts and updates from many different social media feeds. It creates an organized view of social posts on a specific topic and are often used to display user-generated content on live social walls.

TABLE 4
User Database Data

| | | | |
|---|---|---|---|
| User ID | JS1234 | JS1234 | JS1234 |
| Follower ID | HY8569 | IT8527 | RW4569 |
| Code for Followers | 654123-SOI2 | 654123-SOI2 | 654123-SOI2 |
| Follower E-mail | HY8569@gmail.com | IT8527@yahoo.com | RW4569@gmail.com |
| Follower Phone | 781-654-8972 | 231-456-7891 | 654-987-3217 |
| Follower | 123 Main Street, | 58 Elm Street, | 96 2nd Ave, Salt |
| Address | Boston, MA | Burlington, VT | Lake City, UT |

Operation of a set of user device downline program instructions may cause the user device 140 to continuously poll to receive the code and link from the administration network computer 110 to allow the purchaser/distributor to pass the code and link to the user's followers stored in the user device user database. Functioning of the downline program instructions may be as follows. The process begins with the user device 140 continuously polling for the code and the link from the administration network computer 110. The user device 140 receives the code and the link from the administration network computer 110. The user device 140 provides a selection of the first follower in the user device user database. The user device 140 extracts the followers contact information stored in the user device user database. Then the user device 140 sends the code and link to the follower's contact information. The code and link may be shared on social media sites, such as Twitter, Instagram, Facebook, etc. This may allow the user's followers to receive the code and link based on communications that use one or more of these social media accounts. The user device 140 may then determine if there are more followers remaining in the user device user database. If it is determined that there are more followers stored in the user device user database, the user device 140 selects the next user stored in the user device user database. When the user device 140 determines that there are no more followers remaining in the user device user database, then the process may end.

Methods of the present disclosure may include a user device 140 polling for a new universal resource locator (URL) that may have been detected after a quick release (QR) code scanner scans a QR code. The data captured by the QR code scanner may contain data in addition to or in lieu of a URL. The administration network computer 110 may then send the URL to a web browser on the user device 140 so that the user device is directed to the website the URL points to. Third parties may design this webpage so that users can easily refer others to make the same purchase they did or purchase from the same third party or third party computer. Website URLs may be product, user, location, or discount code specific, or may be general but could require the user to provide information before granting the user a referral code or link.

A third party network computer 160 may execute administration program instructions to cause the third party network computer 160 to connect to the administration network computer 110, send the data for the products to be purchased, receive a link from the administration network computer 110, store the link in a third party network database, and return to executing a set of base program instructions. The process may begin with the third party network computer 160 administration program instructions being initiated by the third party network base program instructions. The third party network 160 may connect to the administration network computer 110 and then the third party network computer 160 may send third party network database data to the administration network computer 110. Then the third party network computer 160 may store the link in the third party network third party database.

Operation of a third party network discount program code instructions may include extracting a link sent by the user device 140 and comparing it to data stored at the third party network third party database. This may result in the identification of a corresponding discount for a selected product. This process may include identifying whether a user entered a code or not, after which a discount is applied, and the order is processed.

The process of applying a discount may begin by extracting the link received from the user. Then the third party network computer 160 may compare data included in the extracted link to data stored at the third party network database. The third party network computer 160 may then extract a corresponding discount from the third party network third party database. Then the third party network computer 160 may apply the extracted discount to the user's order. The third party network computer 160 may then determine if the user entered a code. When it is determined that the user did not enter a code, the third party network computer 160 may send the user data to the administration network computer 110 without a code. When it is determined that the user entered a code, the third party network computer 160 may send the code and the user data to the administration network computer 110. Next, the third party network computer 160 may process the user's order.

A third party network third party database may store information about the products that may be purchased. This the third party network database may include local media for the product or service, where this local media may refer to the various types of media, such as photos, videos, text, sounds, haptics, online product descriptions, etc. for enhanced marketing.

Table 5 illustrates data that may be stored at a third party database. This data may include information about the products enrolled in the MLM system as well as a link created by execution of the administration network vendor program instructions. The third party network database may cross-reference a product ID, and product description, an original cost of the product, a discount provided by the third party for the product, a cost of the product with the discount, a compensation plan decay rate which the third party enters, and a link received from the administration network computer. The third party network third party database may include the rates of exchange for product returns, marketing materials, airline sky miles, etc. Product returns may refer to a process in which a customer or consumer takes previously purchased product, merchandise, or goods back to the retailer, and in turn receive a refund in the original form of payment, exchange for another product (identical or different), or a store credit.

The information about the product or service which may be advertisements to the network, or as seen on TV sales. Advertisements to the network may refer to the advertisement provided to the MLM system from the third party offering a product, good or service. These as seen on TV sales may refer to a generic nameplate for products advertised on television in the United States for direct response mail-order through a toll-free telephone number. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media and all audio or video media. Airline sky miles may refer to a loyalty program offered by airlines and/or credit cards. Typically, consumers accumulate a set amount of miles based on how much is spent on a ticket or a credit card and are also known as frequent flyer miles or travel points.

TABLE 5
Third Party Database Data

| | |
|---|---|
| ID | 654123 |
| Item | Drill |
| Original Cost | $59.00 |
| Discount | 15% |
| Discount Cost | $50.15 |
| Compensation Decay Rate | 50% |
| Link | HDDrill654123 |

Functioning of the influence program instructions 135 may be as follows. The process begins with the administration network computer 110 polling for product data from the third party network computer 160. Product data includes at least the product ID, user ID, original cost, discount, and decay rate. The administration network computer 110 compares the product ID from the product data send by the third party network computer 160 to the product ID in a rules database. The administration network computer 110 determines if there is an identical ID in the product data and the rules database. If there is a matching product ID, the administration network computer 110 extracts the rest of the data stored in that entry of the rules database.

The administration network computer 110 determines if the user ID from the product data matches one of the extracted valid user IDs. When the user ID is valid, the administration network computer 110 determines if the original cost component of the product data is above or equal to the minimum original cost from the rules database for that product. When the original cost is not above the minimum original cost from the rules database for that product, the cost may be set to the minimum original cost instead of denying the entire product. When the original cost is above the minimum original cost, the administration network computer 110 determines whether the original cost component of the product data is below or equal to the maximum original cost from the rules database for that product. If the original cost is not below the maximum original cost from the rules database for that product, the cost may be set to the maximum original cost instead of denying the entire product.

The administration network computer 110 determines if the discount component of the product data is above or equal to the minimum discount from the rules database for that product. If the discount is not above the minimum discount from the rules database for that product it may be set to the minimum discount instead of denying the entire product. When the discount is above the minimum discount, the administration network computer 110 may determine whether the discount component of the product data is below or equal to the maximum discount from the rules database for that product. When the discount is not below the maximum discount from the rules database for that product, the discount applied may be set to the maximum discount instead of denying the entire product.

The administration network computer 110 may determine whether the decay rate component of the product data is above or equal to the minimum decay rate from the rules database for that product. When the decay rate is not above the minimum decay rate from the rules database for that product, the decay rate may be set to the minimum decay rate instead of denying the entire product. When the decay rate is above the minimum decay rate, the administration network computer 110 determines whether the decay rate component of the product data is below or equal to the maximum decay rate from the rules database for that product. When the decay rate is not below the maximum decay rate from the rules database for that product, the applied decay rate may be set to the maximum decay rate instead of denying the entire product.

If none of the parameters fall outside the allowed values, the administration network computer 110 may store the product data in the administration database 130. The administration network computer 110 may send an update to the third party network computer 160 that the product has been registered. This update may be, for example, a Boolean TRUE, or the string “allowed”. If one or more of the parameters for the product fall outside the allowed values, the administration network computer 110 sends an update to the third party network computer 160 that the product has been denied. This update may be, for example, a Boolean TRUE, or the string “denied”, and may also contain the reasons the product was denied.

Table 6 illustrates data that may be stored at a database accessible by an administration computer. This data may include information that cross-references advertisement information with user IDs and follower codes. Users may have provided several different forms of advertising media that can be shared with their followers and computing devices of these followers may be sent links that include a follower code in table 6 and may include links that point to or that include one or more media files. Note that user JS12345 is associated with follower code 654123-SO12, with marketing text (“I Love this new Drill”) and with three different media files (Drill.mov, Drill.png, and Drill.mp3). These follower codes may be linked to the user and to a product based on specific information included in the follower code. In certain instances based on the follower codes being unique. Note that user JS12345 may be upline of user HY8570 for sales related to a particular type of drill, yet each user may be associated with a same chain of users that can receive compensations when their advertising materials generate new sales of the drill.

TABLE 6
Administration Advertisement Data

| | | | | |
|---|---|---|---|---|
| User ID | JS12345 | HY8570 | JS1235 | EL51347 |
| Follower Codes | 654123-SOI2 | 654123-SOI3 | 897456-SOI2 | 897456-SOI3 |
| Text | “I Love this New | N/A | “I Do Love | “I don't usually make |
| | Drill” | | this Table | posts, yet had to |
| | | | Saw” | because this product |
| | | | | works so Well” |
| Media File 1 | Drill.mov | New_drill.jpeg | Tablesaw.mov | Cutting_Steel_1.jpeg |
| Media File 2 | Drill.png | N/A | Tablesaw.png | Cutting_Steel_2.jpeg |
| Media File N | Drill.mp3 | N/A | Tablesaw.mp3 | Cutting_Steel_N.jpeg |

TABLE 7
Ranking Database Data

| | | | | | |
|---|---|---|---|---|---|
| Rank | 1 | 2 | . . . | 1000 | 1001 |
| User ID | JS12345 | HY8570 | | JS12345 | EL51347 |
| Item ID | 654123 | 654123 | | 894560 | 89456 |
| Code for Followers | 654123 | 654123 | | 894560 | 89456 |
| Sales | 57,485 | 56,847 | | 14,991 | 14,978 |
| Location | Provo, | Seattle, | | Porvo, UT | Cleveland, |
| | UT | WA | | | OH |
| Change in Rank | 1 | −1 | | −27 | 419 |
| (today) | | | | | |

The data of table 7 cross references data associated advertisement rankings. The data of table 7 may be stored at a ranking database. This data may cross-reference user identifies (IDs) with items they purchased, follower codes that they are associated with, a number or value of sales, location, and changes in rank of advertisements or other marketing materials associated with certain users and specific products. This data may also associate media files (e.g. an picture, audio sound file, video, three-dimensional video, or other media) with particular product and users. These media files may include advertisements generated by the user identified by the user ID. Such files may also include that contain a combination of media files but are not themselves media files, for example, a file saved from video editing software which is not a video but can be opened by the software and converted into a video. In other instances, the database may contain and address or link to a location where local media is stored, for example an ftp address, a google drive folder, an IP address and port that leads to a shared local folder, etc. The database may contain marketing materials provided by a third party or a third party computer, for example, advertising or promotional materials developed by or for license (or subject to licensee's approval) that promote the sale of the licensed product, including but not limited to, television, radio and online advertising, point of sale materials (e.g. posters, counter-cards), packaging advertising, print media and all audio or video media.

Whenever a product sale is recorded, a number (e.g. a number of pieces) or value (e.g. a dollar value) of sales may be updated and each of a set of advertisements may be ranked. The ranking in table 6 vary from a ranking of number one that corresponds to a larger sales volume to a ranking of one thousand and one that corresponds to a lower sales volume. As sales of products associated with specific sets of advertisement media change a over time span (e.g. daily), change in ranking of a particular set of advertisements may change over that time span (e.g. daily). Such data may be used by a user to identify that their advertisement is becoming less effective over time and this may result in that user updating their advertisement or to promote other products to sell via an MLM organization. In certain instances, both the number of sales of a particular product and a value of sales of that product may be tracked. As sales volumes increase, discounts applied to new sales may be adjusted according to a set of rules.

In certain instances, the ranking database may include other datapoints that may be useful to a user to filter by, for example, time, websites the code was posted from, physical characteristics of the user (age, sex, eye color, height, etc.), demographic information about buyers (age range, ethnicity, location, time spent on page, etc.), number of times or places a code was posted, how long after the code was generated (user bought the product) was the code used by a follower to make a purchase, or any other metric, element 1300.

In certain instances, a processor executing instructions used to rank advertisements may include identifying whether the incremented sales of the lower ranking entry is higher than the sales of the higher ranking entry, for example, if rank 456 had 10 sales and was incremented to 11 sales, and rank 455 has 10 sales, then the lower ranking entry now has a higher sales value than the higher ranking entry. When the incremented sales of the lower ranking entry is higher than the sales of the higher ranking entry, the processor may swap the ranks of the two entries. Here, the originally selected entry, which has had its sales value increased, can then be compared to the next entry above it. In other instances, sorting methods may be used to reorganize data stored at a ranking database sales are been made.

In an instance when and incremented sales of the lower ranking entry is equal to or lower than the sales of the higher ranking entry, the processor may store a new sales and rank at the ranking database. Change in ranks may then updated to reflect the difference between the new rank and the old rank. When there is already data in the change in rank parameter of an entry then the processor may add or subtract from than ranking parameter set a new change from the existing data. In other instances, the processor may overwrite the existing change in rank data.

New data added to the ranking database may relate to a new product or a change in an existing product sales. A process may extract a user ID, and item ID, and identify a change in rank of the new data entry. This may result in the processor searching for searches for a matching user ID information associated with a notification rule. Changes is rankings or in other sales information that correspond to a rule may result in notifications being sent to a user device associated with a particular user ID.

In an instance when current data does not correspond to a notification rule a processor may poll for new data from store at the ranking database. When current data corresponds to a notification rule, the processor may generate notifications according to the notification rule. For example, when the notification rule stipulates that an increase in rank of 50 or more require a notification and the change in rank extracted is 51, then a notification may be sent to a user device associated with the rule. In such an instance, when the change in rank is 49, then a notification is not required.

When a notification is required, the processor may identify a contact type and contact for the user ID and may sends the notification to the contact in an appropriate form based on the contact type. For example, a text message will be sent if the contact type is SMS text, an email message will be sent if the contact type is email, and a server will be pinged if the contact type is an IP address, the notification is a simple message, for example, “Moved up X ranks today!”, or “This notification triggered by a drop of X ranks”, or a binary signal, for example, 1/0, or TRUE/FALSE, in another embodiment the form of the notification is also stored in the.

Other examples of notification rules may relate to identifying when to notify users about a change in rank. Program codes associated with a reward module may cause a processor to automatically reward a user for reaching a certain rank. Such notification rules may include include “UP (X)” which notifies the user when their rank has gone up by a value of X or “Down (X)” which notifies the user when their rank wend down by a value of X. A notification rule of “CHANGE(X)” may be used to identify when a notification should be sent to a user when their rank either goes up or down by X. In other instances, a more complex set of notification rules may be utilized, for example, a change in rank over different time periods corresponds to a rule, then notification rules may have to specify over what time-period the change must occur to trigger a notification. In certain instances, a processor at the administration network computer 110 may receive data regarding sales, execute notification program instructions, track rankings, and send notifications to users. In such an instance, the administration network computer 110 may receive the sales data from the third party network computer 160 such that rankings can be identified and notifications can be sent to user devices from administration network computer 110.

Program code at either an administration computer or a third party computer may include a set of notification program instructions and a set of discount program instructions that a processor may execute when identifying when to send notifications, access discount codes, or apply discount codes. A communication may be received from a user device relating to a product, here the processor extracts the link received from the user device. The processor may then identify a discount from data associated with the link or and apply the extracted discount to an order associated with the user. This process may include identifying whether the user entered a code. When the user did not enter a code the processor of the third party network computer may send user data to the administration network computer. When the user did enter the code, the code and the user data may be sent to the administration network computer. This user data may include an ID of the user. The third party network computer may the process the order.

A database associated with the administration network computer or at the third party network computer may store information about items enrolled in the MLM system as well as the links that may have been created at an administration network computer. This database may store data that identifies a cost of the item with the discount, the compensation plan decay rate which the an administration of the third party computer enters, and the link received from the administration network computer. In some instances, this databases may store data that identifies rates of exchange for product returns, marketing materials, airline sky miles, etc.

In some embodiments, product returns may refer to a process in which a customer or consumer takes previously purchased product, merchandise, or goods back to the retailer, and in turn receives a refund in the original form of payment, exchange for another item (identical or different), or a store credit. In some instances, the information about the product or service may be advertisements to the network, or as seen on TV sales. Advertisements to the network may refer to the advertisement provided to the MLM system for an offering of a product, a good, or service. In some embodiments, as seen on TV sales may refer to a generic nameplate for products advertised on television in the United States for direct response mail-order through a toll-free telephone number. In some instances, marketing materials may refer to a means of marketing, advertising or promotional materials developed by or for license (or subject to licensee's approval) that promote the sale of the licensed product, including but not limited to, television, radio and online advertising, point of sale materials (e.g. posters, counter-cards), packaging advertising, print media and all audio or video media. In some embodiments, airline sky miles may refer to a loyalty program offered by airlines and/or credit cards. Typically, consumers accumulate a set amount of miles based on how much is spent on a ticket or a credit card and are also known as frequent flyer miles or travel points.

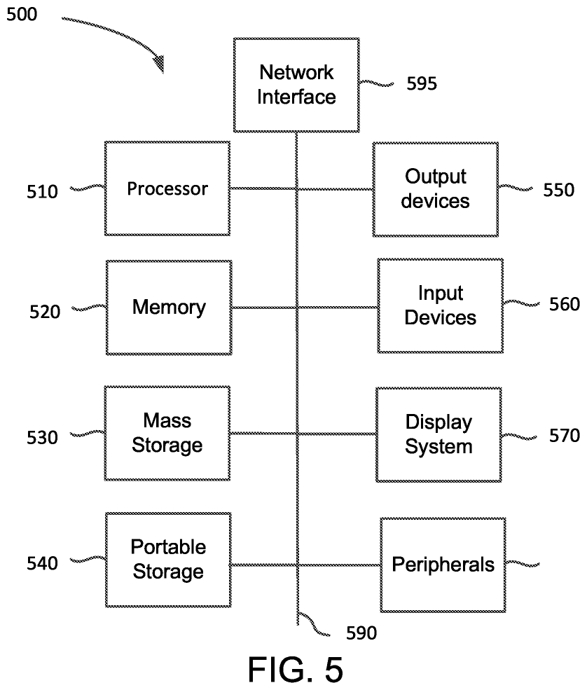

FIG. 5 illustrates a computing system that may be used to implement an embodiment of the present invention. The computing system 500 of FIG. 5 includes one or more processors 510 and main memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, peripheral devices 580, and network interface 595.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a FLASH memory, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD), a plasma display, an organic light-emitting diode (OLED) display, an electronic ink display, a projector-based display, a holographic display, or another suitable display device. Display system 570 receives textual and graphical information, and processes the information for output to the display device. The display system 570 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 580 may include any type of computer support device to add additional functionality to the computer system. For example, peripheral device(s) 580 may include a modem or a router.

Network interface 595 may include any form of computer interface of a computer, whether that be a wired network or a wireless interface. As such, network interface 595 may be an Ethernet network interface, a BlueTooth™ wireless interface, an 802.11 interface, or a cellular phone interface.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 500 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory/disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

What is claimed is:

1. A method for hyperlink-based influence tracking, the method comprising:
receiving data from a first user device that identifies a set of filter criteria;
matching the set of filter criteria to data associated with a product, wherein the product is associated with a code and stored advertising data;
sending the advertisement data associated with the product via a first hyperlink that includes the code to the first user device;
receiving new advertising data related to the product that can be shared with a second user device; and
providing the new advertising data to the second user device via a second hyperlink different from the first hyperlink.

2. The method of claim 1, further comprising identifying the second user device from data received from the first user device.

3. The method of claim 1, further comprising:
identifying that a user of the first user device has purchased the product;
assigning a second code associated with the purchase of the product by the user of the first user device, wherein the second hyperlink to the new advertising data includes the second code;
receiving information that identifies that an order for the product has been received from the second user device via the second hyperlink that includes the second code; and
allocating one or more commissions to the user of the first user device based on the order for the product via the second hyperlink that includes the second code.

4. The method of claim 1, further comprising:
identifying rankings to associate with one or more sets of advertising data; and
organizing the one or more sets of advertising data according to the rankings.

5. The method of claim 1, wherein sending the advertising data to the user device is based on a ranking level of the advertising data among one or more sets of advertising data meeting a threshold level.

6. The method of claim 1, further comprising:
receiving a notification rule from a user device specifying that notification data is sent to the user device when a change in a set of ranking data meets one or more requirements;
identifying that the change in the set of ranking data meets the one or more requirements; and
sending the notification data to the user device based on the change in the set of ranking data meeting the one or more requirements.

7. The method of claim 6, wherein the notification rule is associated with a change in magnitude of the ranking data.

8. The method of claim 1, further comprising:
assigning a third code associated with the order received from the second user device, wherein a third hyperlink includes the third code;
identifying that a new purchase of the product via the third hyperlink is associated with the third code; and
allocating commissions for receipt by the user of the first user device and a second user of the second user device based on the identification of the new purchase of the product via the third hyperlink that includes the third code.

9. The method of claim 1, further comprising associating the user of the first user device as being upline of a user of the second user device based on the user of the second user device purchasing the product via the hyperlink that includes the code.

10. The method of claim 1, further comprising:
receiving marketing data from the second user device, the marketing data associated with an offer to purchase a second product via a hyperlink that includes the second code;
sending the marketing data to the first user device; and
providing commissions for receipt by the second user based on the user of the first user device ordering the second product using the hyperlink that includes the second code, wherein the user of the second user device is classified as being upline of the user of the first user device based on the first user purchasing the second product using the hyperlink that includes the second code.

11. A non-transitory computer-readable storage medium having embodied thereon a program executable by a processor for hyperlink-based influence tracking, the method comprising:
receiving data from a first user device that identifies a set of filter criteria;
matching the set of filter criteria to data associated with a product, wherein the product is associated with a code and stored advertising data;
sending the advertisement data associated with the product via a first hyperlink that includes the code to the first user device;
receiving new advertising data related to the product that can be shared with a second user device; and
providing the new advertising data to the second user device via a second hyperlink different from the first hyperlink.

12. The non-transitory computer-readable storage medium of claim 11, further comprising instructions executable to identify the second user device from data received from the first user device.

13. The non-transitory computer-readable storage medium of claim 11, further comprising instructions executable to:
identify that a user of the first user device has purchased the product;
assign a second code associated with the purchase of the product by the user of the first user device, wherein the second hyperlink to the new advertising data includes the second code;
receive information that identifies that an order for the product has been received from the second user device via the second hyperlink that includes the second code; and
allocate one or more commissions to the user of the first user device based on the order for the product via the second hyperlink that includes the second code.

14. The non-transitory computer-readable storage medium of claim 11, further comprising instructions executable to:
identify rankings to associate with one or more sets of advertising data; and
organize the one or more sets of advertising data according to the rankings.

15. The non-transitory computer-readable storage medium of claim 11, wherein sending the advertising data to the user device is based on a ranking level of the advertising data among one or more sets of advertising data meeting a threshold level.

16. The non-transitory computer-readable storage medium of claim 11, further comprising instructions executable to:
receive a notification rule from a user device specifying that notification data is sent to the user device when a change in a set of ranking data meets one or more requirements;
identify that the change in the set of ranking data meets the one or more requirements; and
send the notification data to the user device based on the change in the set of ranking data meeting the one or more requirements.

17. The non-transitory computer-readable storage medium of claim 16, wherein the notification rule is associated with a change in magnitude of the ranking data.

18. The non-transitory computer-readable storage medium of claim 11, further comprising instructions executable to:
assign a third code associated with the order received from the second user device, wherein a third hyperlink includes the third code;
identify that a new purchase of the product via the third hyperlink is associated with the third code; and
allocate commissions for receipt by the user of the first user device and a second user of the second user device based on the identification of the new purchase of the product via the third hyperlink that includes the third code.

19. The non-transitory computer-readable storage medium of claim 11, further comprising instructions executable to associate the user of the first user device as being upline of a user of the second user device based on the user of the second user device purchasing the product via the hyperlink that includes the code.

20. The non-transitory computer-readable storage medium of claim 11, further comprising executable to:
receive marketing data from the second user device, the marketing data associated with an offer to purchase a second product via a hyperlink that includes the second code;
send the marketing data to the first user device; and
provide commissions for receipt by the second user based on the user of the first user device ordering the second product using the hyperlink that includes the second code, wherein the user of the second user device is classified as being upline of the user of the first user device based on the first user purchasing the second product using the hyperlink that includes the second code.
